(19) United States
(12) Patent Application Publication
(10) Pub. No.: US 2026/0213255 A1
(43) Pub. Date: Jul. 23, 2026

(54) Electrolyte for Lithium Secondary Battery and Lithium Secondary Battery Including the Same

(71) Applicants: SK On Co., Ltd., Seoul (KR); SK Innovation Co., Ltd., Seoul (KR)

(72) Inventors: Geum Yong PARK, Daejeon (KR); Seong Ho JIN, Daejeon (KR); Min Young LEE, Daejeon (KR); In Haeng CHO, Daejeon (KR)

(21) Appl. No.: 19/452,456

(22) Filed: Jan. 19, 2026

(30) Foreign Application Priority Data
Jan. 17, 2025 (KR) 10-2025-0007606

(51) Int. Cl. H01M 10/0525; H01M 10/0562; H01M 10/0567; H01M 10/0569

(52) U.S. Cl. CPC H01M 10/0525; H01M 10/0562; H01M 10/0567; H01M 10/0569; H01M 2300/0065

(57) ABSTRACT

An electrolyte for a lithium secondary battery according to embodiments of the present disclosure includes a sulfonamide-based compound represented by Chemical Formula 1, used as an additive, and a lithium salt. A lithium secondary battery including the electrolyte for a lithium secondary battery may exhibit improved high-temperature storage properties under high-voltage conditions.

### CROSS-REFERENCE TO RELATED APPLICATION AND CLAIM OF PRIORITY

This application claims priority to Korean Patent Application No. 10-2025-0007606 filed on Jan. 17, 2025 in the Ministry Of Intellectual Property (MOIP), the entire disclosure of which is incorporated by reference herein.

### BACKGROUND

### 1. Field

The present disclosure relates to an electrolyte for a lithium secondary battery and a lithium secondary battery including the same. More specifically, the present disclosure relates to an electrolyte for a lithium secondary battery including a solvent and a lithium salt, and a lithium secondary battery including the electrolyte.

### 2. Description of the Related Art

A secondary battery is a battery capable of repeated charging and discharging and with the development of the information communication and display industries, has been widely applied as a power source for portable electronic communication devices such as camcorders, mobile phones, and laptop PCs. In addition, battery pack including secondary battery have recently been developed and applied as power sources for eco-friendly vehicles such as hybrid automobiles.

Examples of secondary batteries may include a lithium secondary batteries, nickel-cadmium batteries, and nickel-hydrogen batteries. Among these, the lithium secondary batteries have been actively researched and developed in that they have a high operating voltage and high energy density per unit weight, and offer advantages in terms of charging speed and weight reduction.

For example, a lithium secondary battery may include: an electrode assembly including a cathode, an anode, and a separation membrane (separator); and an electrolyte that impregnates the electrode assembly. The lithium secondary battery may further include, for example, a pouch-type outer case that accommodates the electrode assembly and the electrolyte.

As the application range of lithium secondary batteries has expanded, longer lifespan, higher capacity, and improved operational stability have been required. Accordingly, a lithium secondary battery that provides uniform output and capacity even during repeated charge and discharge cycles is preferred.

However, with repeated charge and discharge, for example, output and capacity may decrease due to surface damage of a nickel-based lithium metal oxide used as a cathode active material, and side reactions between the nickel-based lithium metal oxide and the electrolyte may occur. In addition, the stability of the battery may deteriorate under harsh environments such as high or low temperatures.

### SUMMARY

An object of the present disclosure is to provide a lithium secondary battery having improved high-temperature storage properties under high-voltage conditions.

An electrolyte for a lithium secondary battery according to exemplary embodiments includes: a compound represented by Chemical Formula 1 below, and a lithium salt.

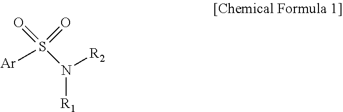

In Chemical Formula 1, Ar is a substituted or unsubstituted aryl group having 6 to 30 carbon atoms, and R₁ and R₂ are each independently a substituted or unsubstituted alkyl group having 1 to 10 carbon atoms, a substituted or unsubstituted arylalkyl group having 7 to 20 carbon atoms, a substituted or unsubstituted alkylsulfonyl group having 1 to 10 carbon atoms, or a substituted or unsubstituted arylsulfonyl group having 6 to 30 carbon atoms, or alternatively, R₁ and R₂ are bonded to each other to form a heterocycle having 3 to 10 carbon atoms.

In some embodiments, in Chemical Formula 1, Ar may be a substituted or unsubstituted phenyl group.

In some embodiments, in Chemical Formula 1, R₁ and R₂ may each independently be a substituted or unsubstituted alkyl group having 1 to 6 carbon atoms, a substituted or unsubstituted arylalkyl group having 7 to 15 carbon atoms, or a substituted or unsubstituted arylsulfonyl group having 6 to 12 carbon atoms.

In some embodiments, in Chemical Formula 1, at least one of R₁ and R₂ may be a phenylsulfonyl group.

In some embodiments, in Chemical Formula 1, at least one of R₁ and R₂ may be a benzyl group.

In some embodiments, in Chemical Formula 1, R₁ and R₂ may be bonded to each other to form a heterocycle having 4 to 8 carbon atoms. In some embodiments, the compound represented by Chemical Formula 1 may include a compound represented by any one of Chemical Formulae 2-1 to 2-7 below.

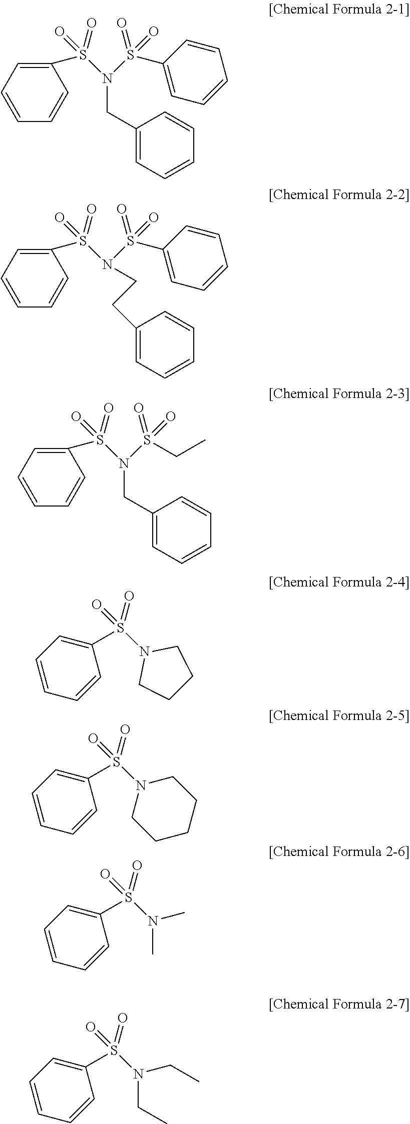

In some embodiments, a content of the compound represented by Chemical Formula 1 may be greater than 0 wt % and 5 wt % or less based on a total weight of the electrolyte.

In some embodiments, the electrolyte for a lithium secondary battery may further include an organic solvent, wherein the organic solvent may include at least one selected from the group consisting of a carbonate-based solvent, an ester-based solvent, an ether-based solvent, a ketone-based solvent, an alcohol-based solvent, and an aprotic solvent.

In some embodiments, the electrolyte may further include at least one auxiliary additive selected from the group consisting of a cyclic carbonate-based compound, a fluorine-containing carbonate-based compound, a lithium phosphate-based compound, a sultone-based compound, a borate-based compound, a sulfate-based compound, and a sulfite-based compound.

In some embodiments, a total content of the auxiliary additive may be greater than 0 wt % and 10 wt % or less based on a total weight of the electrolyte.

A lithium secondary battery according to exemplary embodiments may include: an electrode assembly including a cathode and an anode; and the above-described electrolyte for a lithium secondary battery.

In some embodiments, a solid-electrolyte interphase (SEI) film may be formed on a surface of at least one of the cathode and the anode, and the SEI film may include at least one of sulfur (S) and lithium nitride (Li₃N).

The lithium secondary battery according to exemplary embodiments may exhibit improved high-temperature storage properties by including the compound represented by Chemical Formula 1 in the electrolyte.

The lithium secondary battery according to exemplary embodiments may exhibit improved capacity retention, a reduced resistance increase ratio, and a reduced thickness increase ratio during high-temperature storage. Accordingly, the stability and cycle-life properties of the lithium secondary battery may be enhanced.

The electrolyte may be widely applied in green-technology fields, such as electric vehicles, battery charging stations, and other battery-based applications including solar power generation and wind power generation. In addition, the lithium secondary battery may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and advantages of the present disclosure will be more clearly understood from the following detailed description taken in conjunction with the accompanying drawings, in which:

FIGS. 1 and 2 are a schematic plan view and a schematic cross-sectional view, respectively, illustrating a lithium secondary battery according to exemplary embodiments.

### DETAILED DESCRIPTION

An electrolyte for a lithium secondary battery according to exemplary embodiments may include a compound having a specific structure and a lithium salt. The electrolyte may be a liquid electrolyte or a semi-solid electrolyte, and the semi-solid electrolyte may include a gel polymer electrolyte.

The compound having the specific structure may be a sulfonamide-based compound, and the sulfonamide-based compound may be a compound in which an aromatic group is bound to a sulfur atom of a sulfonamide group.

The sulfonamide-based compound may be used as an additive.

In some embodiments, the additive may be included in an amount greater than 0% by weight (“wt %”) and less than 10 wt %, 8 wt % or less, 6 wt % or less, or 5 wt % or less based on a total weight of the electrolyte.

In addition, the lithium secondary battery according to exemplary embodiments may include an electrode assembly that includes a cathode and an anode; and the electrolyte for a lithium secondary battery. The electrode assembly may include the cathode and the anode repeatedly stacked, and the electrolyte may impregnate the electrode assembly.

In some embodiments, the lithium secondary battery may include a solid electrolyte interphase (SEI) film on a surface of the anode. The solid electrolyte interphase film may be formed from the electrolyte for a lithium secondary battery. The solid electrolyte interphase film may include moieties derived from the compound in the electrolyte. For example, the solid electrolyte interphase film may include functional groups derived from the additive. Accordingly, the high-temperature storage properties of the lithium secondary battery at a high voltage may be improved.

The term “substituted or unsubstituted” as used herein may refer to, for example, being substituted or unsubstituted with one or more substituents selected from the group consisting of a hydrogen atom or a deuterium atom, a halogen atom, a cyano group, a nitro group, an amino group, a silyl group, an oxy group, a thio group, a sulfinyl group, a sulfonyl group, a carbonyl group, an ester group, boron, a phosphine oxide group, a phosphine sulfide group, an alkyl group (e.g., a C₁-C₆₀, or a C₁-C₁₀ alkyl group), an alkenyl group (e.g., a C₂-C₆₀, or a C₂-C₁₀ alkenyl group), an alkynyl group (e.g., a C₂-C₆₀, or a C₂-C₁₀ alkynyl group), an alkoxy group (e.g., a C₁-C₆₀, or a C₁-C₁₀ alkoxy group), a hydrocarbon cyclic group, an aryl group (e.g., a C₆-C₆₀ aryl group), and a heterocyclic group (e.g., a C₁-C₆₀ heterocyclic group). For example, a “substituted alkyl group” may refer to an alkyl group in which at least one hydrogen atom of the alkyl group is substituted with the above-described substituent, thereby allowing a substituent to be further bound to a carbon atom of the alkyl group.

The substituent may include a combination of groups selected from those described above. For example, at least one hydrogen atom of an alkyl group, an aryl group, or the like included as a substituent may be substituted with a hydrogen atom or a deuterium atom, a halogen atom, a cyano group, a nitro group, an amino group, a silyl group, an oxy group, a thio group, a sulfinyl group, a sulfonyl group, a carbonyl group, an ester group, boron, a phosphine oxide group, a phosphine sulfide group, an alkyl group, an alkenyl group, an alkynyl group, a hydrocarbon cyclic group, an aryl group, or a heterocyclic group.

Among the substituents, multivalent substituents such as an amino group, a phosphine sulfide group, a phosphine oxide group, a sulfinyl group, a sulfonyl group, a sulfanyl group, an oxy group, a carbonyl group, and an ester group may be substituted with a C₁-C₁₀ alkyl group, a C₁-C₁₀ alkenyl group, a C₁-C₁₀ alkynyl group, or a C₆-C₁₀ aryl group.

In the term “substituted or unsubstituted Y group having a to b carbon atoms” as used herein, the a to b carbon atoms refers to the number of carbon atoms in the Y group in an unsubstituted state, and does not include the number of carbon atoms in any substituent(s).

As used herein, the “Cₐ-C_{b}” may refer to a hydrocarbon group having a carbon number of a to b.

The term “alkyl group” may refer to a monovalent hydrocarbon group derived from a straight-chain or branched-chain hydrocarbon by the removal of one hydrogen atom. For example, the alkyl group may include a methyl group, an ethyl group, a propyl group, a sec-butyl group, a tert-butyl group, an iso-butyl group, a pentyl group, a neopentyl group, a 2-ethylbutyl group, a 3,3-dimethylbutyl group, a hexyl group, a heptyl group, an octyl group, etc.

The term “aryl group” may refer to a monovalent hydrocarbon group derived from a hydrocarbon group having an aromatic structure by the removal of one hydrogen atom. For example, the aryl group may include a group in which a plurality of aromatic rings are directly linked to each other, such as a biphenyl group. The aryl group may include, for example, a phenyl group, a naphthyl group, an anthracenyl group, a phenanthrenyl group, a pyrenyl group, a fluorenyl group, a tetracenyl group, a biphenyl group, a terphenyl group, a quaterphenyl group, a perylenyl group, a chrysenyl group, etc.

A group in which two or more aryl rings are fused or linked to each other via an alicyclic hydrocarbon ring such as a fluorenyl group, may also be included in the category of the aryl group.

For example, a biphenyl group may be construed either as an aryl group or as a phenyl group substituted with another phenyl group.

As used herein, the term “arylalkyl group” may refer to a hydrocarbon group in which one or more hydrogen atoms of a hydrocarbon group having an aromatic structure are substituted with an alkyl group. The arylalkyl group may include, for example, a benzyl group, a phenylethyl group, a naphthylmethyl group, an anthracenylmethyl group, a phenanthrenylethyl group and the like.

The term “alkylsulfonyl group” as used herein may refer to a monovalent organosulfur group in which a sulfonyl group (—SO₂) is bonded to a monovalent alkyl group derived from a straight-chain or branched-chain hydrocarbon group (alkyl group) by the removal of one hydrogen atom. The alkyl sulfonyl group may include, for example, a methylsulfonyl group, an ethylsulfonyl group, a propylsulfonyl group, a butylsulfonyl group, a hexylsulfonyl group and the like.

The term“arylsulfonyl group” as used herein may refer to a monovalent organosulfur group in which a sulfonyl group (—SO₂) is bonded to a monovalent aryl group derived from a hydrocarbon group (aryl group) having an aromatic structure by the removal of one hydrogen atom. The arylsulfonyl group may include, for example, a phenylsulfonyl group, a naphthylsulfonyl group, an anthracenylsulfonyl group, a phenanthrenylsulfonyl group, and the like.

The term “heterocycle” as used herein may refer to a monovalent cyclic hydrocarbon group having an aromatic or non-aromatic ring structure that contains, in addition to carbon, one or more heteroatoms such as nitrogen (N), oxygen (O), or sulfur (S). The heterocycle may include, for example, pyrrole, furan, thiophene, imidazole, pyridine, quinoline, indole, purine and the like.

Hereinafter, the embodiments of the present disclosure will be described in detail. However, the embodiments are merely illustrative, and the present disclosure is not limited to the specific embodiments described as examples.

The electrolyte for a lithium secondary battery according to the exemplary embodiments may include a sulfonamide-based compound, specifically, a compound represented by Chemical Formula 1 below.

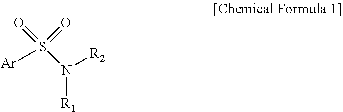

In Chemical Formula 1, Ar may be a substituted or unsubstituted aryl group having 6 to 30 carbon atoms, and R₁ and R₂ may each be independently a substituted or unsubstituted alkyl group having 1 to 10 carbon atoms, a substituted or unsubstituted arylalkyl group having 7 to 20 carbon atoms, a substituted or unsubstituted alkylsulfonyl group having 1 to 10 carbon atoms, or a substituted or unsubstituted arylsulfonyl group having 6 to 30 carbon atoms, or alternatively, R₁ and R₂ may be bonded to each other to form a heterocycle having 3 to 10 carbon atoms.

In some embodiments, in Chemical Formula 1, Ar may be a substituted or unsubstituted phenyl group.

In some embodiments, in Chemical Formula 1, R₁ and R₂ may each independently be a substituted or unsubstituted alkyl group having 1 to 6 carbon atoms, a substituted or unsubstituted arylalkyl group having 7 to 15 carbon atoms, or a substituted or unsubstituted arylsulfonyl group having 6 to 12 carbon atoms.

In some embodiments, in Chemical Formula 1, at least one of R₁ and R₂ may be a phenylsulfonyl group.

In some embodiments, in Chemical Formula 1, at least one of R₁ and R₂ may be a benzyl group. When at least one of R₁ and R₂ in Chemical Formula 1 includes a benzyl group, a more stable solid electrolyte interphase (SEI) film may be formed on a surface of an electrode.

In some embodiments, in Chemical Formula 1, R₁ and R₂ may be bonded to each other to form a heterocycle having 4 to 8 carbon atoms.

In some embodiments, in Chemical Formula 1, R₁ and R₂ may be bonded to each other to form a heterocycle having a 5-membered heterocycle.

In some embodiments, the compound represented by Chemical Formula 1 may include a compound represented by any one of Chemical Formulae 2-1 to 2-7 below.

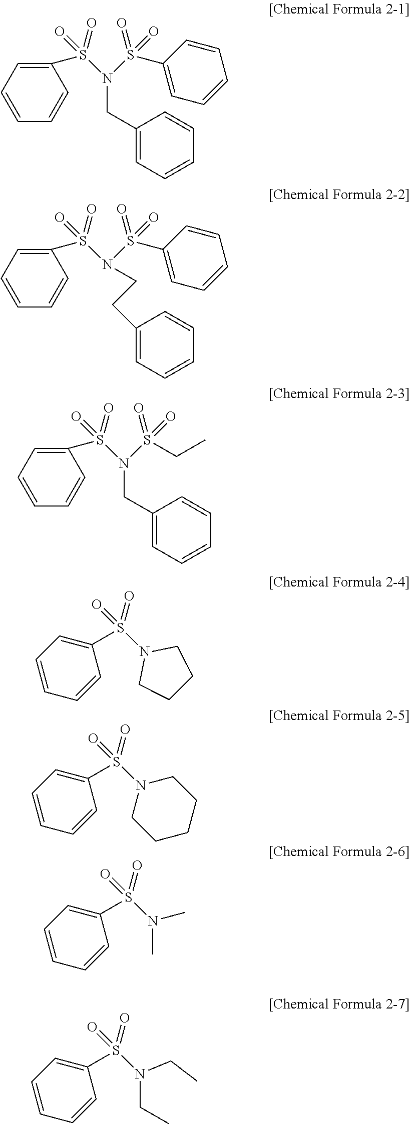

In some embodiments, the sulfonamide-based compound represented by Chemical Formula 1 may form a stable solid electrolyte interface (S) film on a surface of an electrode that is stable at high temperature.

For example, the compound represented by Chemical Formula 1 may decompose and react with a lithium salt during charging and discharging. As a result, the SEI film may include at least one of sulfur (S) and lithium nitride (Li₃N). Accordingly, during high-temperature storage of the lithium secondary battery, an increase in thickness and an increase in internal resistance may be suppressed, and capacity retention may be increased, thereby improving high-temperature stability and cycle-life properties of the lithium secondary battery.

For example, a stable S-containing SEI film may be formed to stably protect the surface of the electrode, thereby stabilizing an electrode interface and suppressing side reactions with the electrolyte. In addition, an increase in internal resistance and an increase in thickness of the battery during high-temperature storage may be suppressed.

For example, a highly ion-conductive SEI film including Li₃N may be formed, thereby facilitating the migration of lithium ions between the electrode and the electrolyte, suppressing an increase in internal resistance and increasing capacity retention during high-temperature storage.

In some embodiments, a content of the compound represented by Chemical Formula 1 may be greater than 0 wt % and 5 wt % or less, or may be 0.1 wt % to 5 wt % based on a total weight of the electrolyte.

For example, the content of the compound represented by Chemical Formula 1 may be 0.2 wt % or more, 0.3 wt % or more, 0.4 wt % or more, 0.5 wt % or more, or 1 wt % or more based on the total weight of the electrolyte. In addition, the content of the compound represented by Chemical Formula 1 may be 5 wt % or less, 4 wt % or less, 3.5 wt % or less, 3 wt % or less, or 2 wt % or less based on the total weight of the electrolyte.

Within the above range, a uniform and stable SEI film may be formed on a surface of the electrode, and the high-temperature storage properties of the lithium secondary battery may be improved.

The electrolyte for a lithium secondary battery according to exemplary embodiments may further include at least one auxiliary additive selected from the group consisting of a cyclic carbonate-based compound, a fluorine-containing carbonate-based compound, a lithium phosphate-based compound, a sultone-based compound, a borate-based compound, a sulfate-based compound, and a sulfite-based compound.

In some embodiments, a total content of the auxiliary additive may be greater than 0 wt % and 10 wt % or less based on the a total weight of the electrolyte. For example, the auxiliary additive may be included in an amount less than 10 wt %, 8 wt % or less, 6 wt % or less, or 5 wt % or less based on a total weight of the electrolyte.

When the compound represented by Chemical Formula 1 is used in combination with the auxiliary additive, a lithium secondary battery having further improved low-temperature properties and high-temperature storage properties may be efficiently provided.

For example, the cyclic carbonate-based compound may include vinylene carbonate (VC), vinyl ethylene carbonate (VEC), or the like.

For example, the fluorine-containing carbonate-based compound may include a fluorine atom or a fluorine-containing substituent (e.g., a fluorine-substituted alkyl group such as —CF₃) bound to at least one carbon atom of the carbonate-based compound.

In some embodiments, the fluorine-containing carbonate-based compound may include a fluorine-containing cyclic carbonate-based compound having a cyclic structure. For example, the fluorine-containing cyclic carbonate-based compound may have a 5- to 7-membered ring structure.

For example, the fluorine-containing cyclic carbonate-based compound may include fluoroethylene carbonate (FEC), etc.

For example, the lithium phosphate-based compound may include lithium difluoro bis(oxalato) phosphate, lithium difluoro phosphate, etc.

In some embodiments, the sultone-based compound may include at least one selected from the group consisting of an alkyl sultone-based compound and an alkenyl sultone-based compound.

In some embodiments, the sultone-based compound may include both an alkyl sultone-based compound and an alkenyl sultone-based compound.

For example, the alkyl sultone-based compound may include 1,3-propane sultone (PS), 1,4-butane sultone, etc.

For example, the alkenyl sultone-based compound may include ethene sultone, 1,3-propene sultone (PRS), 1,4-butene sultone, 1-methyl-1,3-propene sultone, etc.

For example, the borate-based compound may include lithium bis(oxalato) borate, etc.

In some embodiments, the sulfate-based compound may include a cyclic sulfate-based compound having a cyclic structure. The cyclic sulfate-based compound may have a 5- to 7-membered ring structure.

For example, the cyclic sulfate-based compound may include 1,2-ethylene sulfate (ESA), trimethylene sulfate (TMS), 1,2-propylene sulfate, methyltrimethylene sulfate (MTMS), etc.

In some embodiments, the sulfite-based compound may include a cyclic sulfite-based compound having a cyclic structure.

For example, the cyclic sulfite-based compound may include ethylene sulfite, butylene sulfite, etc.

In some embodiments, a total content of auxiliary additives included in the electrolyte for a lithium secondary battery may be greater than 0 wt % and 10 wt % or less, and may be 0.01 wt % to 10 wt % based on a total weight of the electrolyte.

For example, the total content of auxiliary additives included in the electrolyte for a lithium secondary battery may be 0.01 wt % or more, 0.05 wt % or more, 0.5 wt % or more, 0.8 wt % or more, 1.0 wt % or more, 1.5 wt % or more, or 2 wt % or more based on the total weight of the electrolyte. In addition, the total content of auxiliary additives included in the electrolyte for a lithium secondary battery may be 9 wt % or less, 8 wt % or less, or 7 wt % or less based on the total weight of the electrolyte.

Within the above range, the durability of the SEI film may be improved without inhibiting the function of the compound represented by Chemical Formula 1. Accordingly, the high-temperature storage properties of the lithium secondary battery may be further improved.

In some embodiments, the electrolyte for a lithium secondary battery may include an organic solvent. The organic solvent may include an organic compound that provides sufficient solubility for the lithium salt, the compound represented by Chemical Formula 1, and the auxiliary additive, and being non-reactive in the lithium secondary battery. Here, the organic solvent may be included in an amount of 10 wt % or more based on a total weight of the electrolyte.

For example, a total content of organic solvents included in the electrolyte for a lithium secondary battery may be 50 wt % or more, 60 wt % or more, or 70 wt % or more based on a total weight of the electrolyte.

In some embodiments, the organic solvent may include at least one of a carbonate-based solvent, an ester-based solvent, an ether-based solvent, a ketone-based solvent, an alcohol-based solvent, and an aprotic solvent.

In some embodiments, the organic solvent may include a carbonate-based solvent, and the carbonate-based solvent may include a linear carbonate-based solvent and a cyclic carbonate-based solvent.

For example, the linear carbonate-based solvent may include dimethyl carbonate (DMC), ethyl methyl carbonate (EMC), diethyl carbonate (DEC), methyl propyl carbonate, ethyl propyl carbonate, dipropyl carbonate, etc.

For example, the cyclic carbonate-based solvent may include ethylene carbonate (EC), propylene carbonate (PC), butylene carbonate, etc.

In some embodiments, the organic solvent may include, on a volume basis, a greater amount of the linear carbonate-based solvent than the cyclic carbonate-based solvent.

In some embodiments, in the organic solvent, a ratio of a volume of the cyclic carbonate-based solvent to a volume of the linear carbonate-based solvent may be 1/9 to 1. For example, the volume ratio may be 1/9 to ⅔, ⅙ to ⅔, or ¼ to ⅔. Within this range, the high-temperature storage properties and low-temperature properties of the lithium secondary battery may be further improved.

For example, the ester-based solvent may include at least one of methyl acetate (MA), ethyl acetate (EA), n-propyl acetate (n-PA), 1,1-dimethylethyl acetate (DMEA), methyl propionate (MP), ethyl propionate (EP), γ-butyrolactone (GBL), decanolide, valerolactone, mevalonolactone, and caprolactone.

For example, the ether-based solvent may include at least one of dibutyl ether, tetraethylene glycol dimethyl ether (TEGDME), diethylene glycol dimethyl ether (DEGDME), dimethoxyethane, tetrahydrofuran (THF), and 2-methyltetrahydrofuran.

For example, the ketone-based solvent may include cyclohexanone, etc.

For example, the alcohol-based solvent may include at least one of ethyl alcohol and isopropyl alcohol.

For example, the aprotic solvent may include at least one of a nitrile-based solvent, an amide-based solvent (e.g., dimethylformamide), a dioxolane-based solvent (e.g., 1,3-dioxolane), and a sulfolane-based solvent.

In some embodiments, the electrolyte may include a lithium salt.

The lithium salt may be represented by L⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₂⁻, (CF₃)₃PF₃⁻, (CF₃)₄PF₂⁻, (CF₃)₅PF⁻, (CF₃)₅P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂CH⁻, (SF₅)₃C⁻, (CF₃SO₂)C⁻, CF₃(CF₂)₇SO₃⁻, CF₃CO₂⁻, CH₃CO₂⁻, SCN⁻, (CF₃CF₂SO₂)₂N⁻, and the like may be exemplified.

In some embodiments, the lithium salt may include at least one selected from the group consisting of LiPF₆, LiClO₄, LiBF₄, LiFSI, LiTFSI, LiSO₃CF₃, LiBOB, LiFOB, LiDFOB, LiDFBP, LiTFOP, LiPO₂F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, and LiC(CF₃SO₂)₃.

In one embodiment, the lithium salt may include at least one selected from the group consisting of LiPF₆, LiFSI and LiTFSI.

In some embodiments, the lithium salt may be included in a concentration of 0.01 M to 5V, 0.01 M to 4 M, 0.5 M to 3 M, or 0.5 M to 2 M, based on the organic solvent. Within this concentration range, lithium ions and/or electrons may migrate smoothly during charging and discharging of the lithium secondary battery.

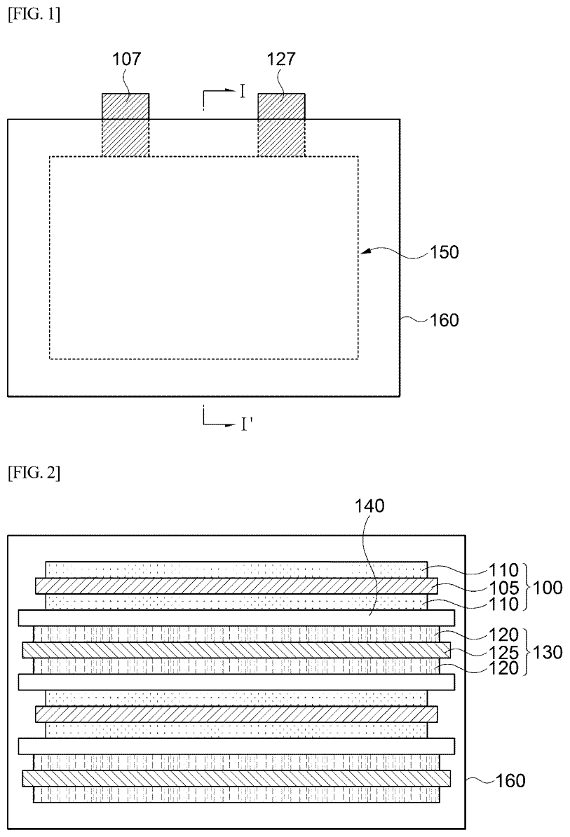

FIGS. 1 and 2 are a schematic plan view and a schematic cross-sectional view, respectively, illustrating a lithium secondary battery according to exemplary embodiments. FIG. 2 is a cross-sectional view taken along line I-I′ of FIG. 1.

Referring to FIGS. 1 and 2, the lithium secondary battery may include an electrode assembly 150 including a cathode 100 and an anode 130, and the electrode assembly 150 may further include a separator 140, a solid electrolyte layer, or a semi-solid electrolyte layer interposed between the cathode 100 and the anode 130.

For example, the electrode assembly 150 may include a plurality of cathodes 100 and anodes 130 repeatedly stacked, and the electrode assembly 150 may be accommodated in a case 160 together with the above-described electrolyte according to exemplary embodiments and may be impregnated therewith.

The cathode 100 may include a cathode current collector 105 and a cathode active material layer 110 disposed on at least one surface of the cathode current collector 105.

For example, the cathode current collector 105 may include stainless steel, nickel, aluminum, titanium, or an alloy thereof. The cathode current collector 105 may also include aluminum or stainless steel having a surface treated with carbon, nickel, titanium or silver. For example, the cathode current collector 105 may have a thickness of 10 μm to 50 μm.

For example, the cathode active material may include a compound capable of reversibly intercalating and deintercalating lithium ions.

In some embodiments, the cathode 100 may include a cathode active material including a lithium metal oxide. The lithium metal oxide may further include at least one of cobalt (Co), manganese (Mn) and aluminum (Al).

In some embodiments, the cathode active material may include lithium metal oxide particles having a structure represented by Chemical Formula 3 below.

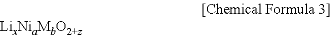

In Chemical Formula 3, x, a, b and z may satisfy 0.9≤x≤1.2, 0.6≤a≤0.99, 0.01≤b≤0.4, and −0.5≤z≤0.1. As described above, M may include Co, Mn and/or Al.

The chemical structure represented by Chemical Formula 3 indicates a bonding relationship among elements included in a layered structure or a crystal structure of the cathode active material, and does not exclude the presence of additional elements. For example, M includes Co and/or Mn, and Co and/or Mn may be provided as main active elements of the cathode active material together with Ni. Here, it should be understood that Chemical Formula 3 is provided to express the bonding relationship between the main active elements, and is a Chemical formula encompassing the introduction and substitution of additional elements.

In an embodiment, the cathode active material may further include auxiliary elements which are added to the main active elements, in order to enhance chemical stability of the layered stucture/crystal structure. The auxiliary element may be incorporated into the layered structure/crystal structure together with the main active elements to form bonds, and it should be understood that this case is also included within the chemical structure range represented by Chemical Formula 3.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may also act, for example, as an auxiliary active element that contributes to the capacity and/or output properties of the cathode active material together with Co or Mn, such as Al.

For example, the cathode active material or the lithium metal oxide may include a layered structure or a crystal structure represented by Chemical Formula 3-1 below.

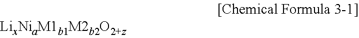

In Chemical Formula 3-1, M1 may include Co, Mn and/or Al. M2 may include the above-described auxiliary elements. In Chemical Formula 3-1, x, a, b1, b2 and z may satisfy 0.9≤x≤1.2, 0.6≤a≤0.99, 0.01≤b1+b2≤0.4, and −0.5≤z≤0.1.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may be present on the surface of the lithium metal oxide particles, or may penetrate through the surface of lithium-nickel metal composite oxide particles to be incorporated into the bonding structure represented by Chemical Formula 3 or Chemical Formula 3-1 above.

The cathode active material may include a nickel-cobalt-manganese (NCM)-based lithium oxide. In this case, an NCM-based lithium oxide with an increased content of nickel may be used.

Nickel (Ni) may serve as a transition metal associated with the output and capacity of the lithium secondary battery. Therefore, as described above, by employing a high-nickel-content (high-Ni) composition in the cathode active material, ahigh-capacity cathode and ahigh-capacity lithium secondary battery may be provided.

However, as the Ni content increases, the long-term storage stability and cycle-life stability of the cathode or the secondary battery may be relatively reduced, and side reactions with the electrolyte may also increase. Nevertheless, according to exemplary embodiments, electrical conductivity may be maintained by including Co, while cycle-life stability and capacity retention properties may be improved through Mn.

A content of Ni (e.g., a molar fraction of nickel based on a total molar amount of nickel, cobalt and manganese) in the NCM-based lithium oxide may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, a manganese (Mn)-rich active material, a lithium (Li)-rich layered oxide (LLO)/over-lithiated oxide (OLO)-based active material, or a cobalt (Co)-less active material, which has a chemical structure or a crystal structure represented by Chemical Formula 4.

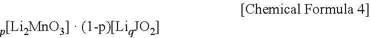

In Chemical Formula 4, p and q may satisfy 0<p<1, and 0.9≤q≤1.2, and J may include at least one element selected from Mn, Ni, Co, Fe, Cr, V, Cu, Zn, Ti, Al, Mg and B.

For example, a cathode slurry may be prepared by mixing the cathode active material in a solvent. The cathode slurry may be applied to the cathode current collector 105, and then dried and roll-pressed to prepare the cathode active material layer 110. The coating process may be performed using methods such as gravure coating slot die coating simultaneous multilayer die coating imprinting doctor blade coating dip coating bar coating or casting etc., but is not limited thereto. The cathode active material layer 110 may further include a binder, and optionally may further include, a conductive material, a thickener or the like.

Non-limiting examples of the solvent used in the preparation of the cathode active material layer 110 may include N-methyl-2-pyrrolidone (NMP), dimethylformamide, dimethylacetamide, N,N-dimethylaminopropylamine, ethylene oxide, tetrahydrofuran and the like.

The binder may include polyvinylidene fluoride (PVDF), poly(vinylidene fluoride-co-hexafluoropropylene), polyacrylonitrile, polymethyl methacrylate, acrylonitrile butadiene rubber (NBR), poly(butadiene) rubber (BR), styrene-butadiene rubber (SBR) and the like. In an embodiment, a PVDF-based binder may be used as the cathode binder.

The conductive material may be added to the cathode active material layer 110 to enhance the conductivity thereof and/or the mobility of lithium ions or electrons. For example, the conductive material may include carbon-based conductive materials such as graphite, carbon black, acetylene black, Ketjen black graphene, carbon nanotubes, vapor-grown carbon fibers (VGCF), and carbon fibers; and/or metal-based conductive materials such as tin, tin oxide, and titanium oxide; as well as perovskite materials such as LaSrCoO₃, and LaSrMnO₃, but is not limited thereto.

The cathode active material layer 110 may further include a thickener and/or a dispersant. For example, the cathode active material layer 110 may include a thickener such as carboxy methyl cellulose (CMC).

The anode 130 may include an anode current collector 125, and an anode active material layer 120 disposed on at least one surface of the anode current collector 125.

Non-limiting examples of the anode current collector 125 may include a copper foil, nickel foil, stainless steel foil, titanium foil, nickel foam, copper foam, or a polymer substrate coated with a conductive metal. The anode current collector 125 may have, for example, a thickness of 10 μm to 50 μm, but is not limited thereto.

The anode active material layer 120 may include an anode active material. As the anode active material, a material capable of adsorbing and desorbing lithium ions may be used. For example, as the anode active material, carbon-based materials such as crystalline carbon, amorphous carbon, carbon composites, or carbon fibers, etc.; lithium metal; a lithium alloy; a silicon (Si)-containing material or a tin (Sn)-containing material may be used.

For example, the amorphous carbon may include hard carbon, soft carbon, coke, mesocarbon microbead (MCMB), mesophase pitch-based carbon fiber (MPCF) or the like.

For example, the crystalline carbon may include graphitic carbon such as natural graphite, artificial graphite, graphitized coke, graphitized MCMB, graphitized MPCF or the like.

The lithium metal may include pure lithium metal or lithium metal having a protective layer formed thereon for suppressing dendrite growth or the like. In one embodiment, a lithium metal-containing layer deposited or coated on the anode current collector 125 may also be used as the anode active material layer 120. In an embodiment, a lithium thin-film layer may also be used as the anode active material layer 120.

Elements contained in the lithium alloy may include aluminum, zinc, bismuth, cadmium, antimony, silicon, lead, tin, gallium, indium, etc.

The silicon-containing material may provide further improved capacity properties. The silicon-containing material may include Si, SiO (0<x<2), a metal-doped SiOₓ (0<x<2), a silicon-carbon composite, etc. The metal may include lithium and/or magnesium, and the metal-doped SiOₓ (0<x<2) may include a metal silicate.

For example, the anode active material may be mixed in a solvent to prepare an anode slurry. The anode slurry may be coated or deposited on the anode current collector 125, and then dried and roll-pressed to prepare the anode active material layer 120. The coating process may be performed using methods such as gravure coating slot die coating simultaneous multilayer die coating imprinting doctor blade coating dip coating bar coating or casting etc., but is not limited thereto. The anode active material layer 120 may further include a binder, and optionally may further include a conductive material, a thickener or the like.

In some embodiments, the anode 130 may include the anode active material layer 120 in the form of lithium metal formed through a deposition/coating process.

Non-limiting examples of solvents for the anode active material layer 120 may include water, purified water, deionized water, distilled water, ethanol, isopropanol, methanol, acetone, n-propanol, t-butanol and the like.

The above-described materials that can be used when preparing the cathode as the binder, conductive material and thickener may also be used for the anode.

In some embodiments, a styrene-butadiene rubber (SBR)-based binder, carboxymethyl cellulose (CMC), polyacrylic acid-based binder, poly(3,4-ethylenedioxythiophene) (PEDOT)-based binder, and the like may be used as an anode binder.

A separator 140 may be interposed between the cathode 100 and the anode 130. The separator 140 may be configured to prevent an electrical short-circuit between the cathode and the anode, and to allow the flow of ions. For example, the separator 140 may have a thickness of 10 μm to 20 μm, but the present disclosure is not limited thereto.

For example, the separator 140 may include a porous polymer film or a porous nonwoven fabric. The porous polymer film may include a polyolefin-based polymer such as an ethylene polymer, propylene polymer, ethylene/butene copolymer, ethylene/hexene copolymer, or ethylene/methacrylate copolymer, etc. The porous nonwoven fabric may include glass fibers having a high melting point, polyethylene terephthalate fibers, etc. The separator 140 may also include a ceramic-based material. For example, inorganic particles may be coated on the polymer film or dispersed within the polymer film to improve heat resistance.

The separator 140 may have a single-layer or multilayer structure including the above-described polymer film and/or non-woven fabric.

According to exemplary embodiments, the cathode 100, the anode 130, and the separator 140 may be repeatedly disposed to form the electrode assembly 150. In some embodiments, the electrode assembly 150 may be a winding type, a stacking type, a z-folding type, or a stacked-folding type.

The electrode assembly 150 may be accommodated in the case 160 together with the above-described electrolyte according to the exemplary embodiments to define a lithium secondary battery.

For example, electrode tabs (cathode tabs and anode tabs) may protrude from the cathode current collector 105 and the anode current collector 125, respectively, and may extend to one side of the case 160. The electrode tabs may be welded together with the one side of the case 160 and connected to electrode leads (a cathode lead 107 and an anode lead 127) that extend or are exposed to the outside of the case 160.

For example, a pouch-type case, a prismatic case, a cylindrical case, or a coin-type case may be used as the case 160.

Hereinafter, the embodiments of the present disclosure will be further described with reference to specific experimental examples. The examples and comparative examples included in the experimental examples are merely illustrative of the present disclosure and do not limit the scope of the appended claims. It will be apparent to those skilled in the art that various changes and modifications to the examples can be made within the scope and technical spirit of the present disclosure, and it is also understood that such changes and modifications fall within the scope of the appended claims.

### EXAMPLES AND COMPARATIVE EXAMPLES

### Example 1

### (1) Preparation of Electrolyte

A 1.1 M LiPF₆ solution (a mixed solvent of ethylene carbonate (EC)/propylene carbonate (PC)/ethyl methyl carbonate (EMC) in a volume ratio of 10:15:75) was prepared.

Based on the total weight of the electrolyte (100 wt %), 5.0 wt % of fluoroethylene carbonate (FEC), 1.0 wt % of LiPO₂F₂, and 0.5 wt % of PS were added to the LiPF₆ solution, and 0.5 wt % of a compound represented by Chemical Formula 2-1 below were added to prepare an electrolyte.

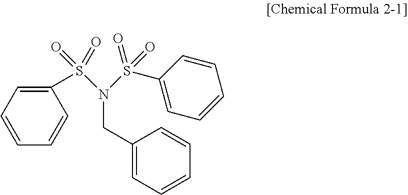 [SMILES: O=S(=O)(c1ccccc1)N(Cc1ccccc1)S(=O)(=O)c1ccccc1]

### (2) Manufacture of Lithium Secondary Battery Sample

A cathode slurry was prepared by mixing LiNi_{0.8}Co_{0.1}Mn_{0.1}O₂ as a cathode active material, carbon black as a conductive material, and polyvinylidene fluoride (PVdF) as a binder in a weight ratio of 92:5:3. The cathode slurry was uniformly applied to an aluminum foil having a thickness of 15 μm, vacuum-dried at 130° C., and roll-pressed to prepare a cathode for a lithium secondary battery.

An anode slurry was prepared by mixing 95 wt % of an anode active material, in which artificial graphite and natural graphite were mixed in a weight ratio of 7:3, 1 wt % of Super-P as a conductive material, 2 wt % of styrene-butadiene rubber (SBR) as a binder, and 2 wt % of carboxymethyl cellulose (CMC) as a thickener.

The anode slurry was uniformly applied to a region of a copper foil (thickness: 15 μm) having a protrusion part (an anode tab) on one side, excluding the protrusion part, and then dried and roll-pressed to prepare an anode.

The cathode and anode prepared as described above were each cut to a predetermined size and stacked. A separator (polyethylene, thickness: 20 μm) was interposed between the cathode and anode to form an electrode assembly. The tab portions of the cathode and the tab portions of the anode were then welded, respectively.

The electrode assembly was placed into a pouch, and three sides of the pouch were sealed, leaving one side open for electrolyte injection. At this time, the portion having the electrode tab was included in the sealed part. After injecting the electrolyte solution prepared in (1) through the electrolyte injection side, the remaining electrolyte injection side was also sealed, and the cell was allowed to be impregnated for 12 hours or more to manufacture a lithium secondary battery sample.

### Example 2

An electrolyte and a lithium secondary battery sample were manufactured in the same manner as in Example 1, except that 0.5 wt % of a compound represented by Chemical Formula 2-4 below was used instead of the compound represented by Chemical Formula 2-1 of Example 1.

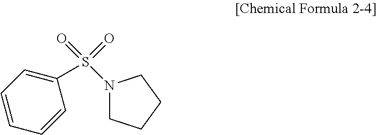 [SMILES: O=S(=O)(c1ccccc1)N1CCCC1]

### Example 3

An electrolyte and a lithium secondary battery sample were manufactured in the same manner as in Example 1, except that 0.5 wt % of a compound represented by Chemical Formula 2-6 below was used instead of the compound represented by Chemical Formula 2-1 of Example 1.

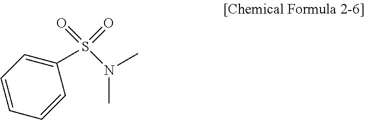

### Example 4

An electrolyte and a lithium secondary battery sample were manufactured in the same manner as in Example 1, except that 0.25 wt % of the compound represented by Chemical Formula 2-1 of Example 1 was used.

### Example 5

An electrolyte and a lithium secondary battery sample were manufactured in the same manner as in Example 1, except that 1.0 wt % of the compound represented by Chemical Formula 2-1 of Example 1 was used.

### Example 6

An electrolyte and a lithium secondary battery sample were manufactured in the same manner as in Example 1, except that 0.25 wt % of the compound represented by Chemical Formula 2-4 was used instead of the compound represented by Chemical Formula 2-1 of Example 1.

### Example 7

An electrolyte and a lithium secondary battery sample were manufactured in the same manner as in Example 1, except that 1.0 wt % of the compound represented by Chemical Formula 2-4 was used instead of the compound represented by Chemical Formula 2-1 of Example 1.

### Example 8

An electrolyte and a lithium secondary battery sample were manufactured in the same manner as in Example 1, except that 0.25 wt % of the compound represented by Chemical Formula 2-6 was used instead of the compound represented by Chemical Formula 2-1 of Example 1.

### Example 9

An electrolyte and a lithium secondary battery sample were manufactured in the same manner as in Example 1, except that 1.0 wt % of the compound represented by Chemical Formula 2-6 was used instead of the compound represented by Chemical Formula 2-1 of Example 1.

### Comparative Example 1

An electrolyte and a lithium secondary battery sample were manufactured in the same manner as in Example 1, except that the compound represented by Chemical Formula 2-1 of Example 1 was not added.

### Comparative Example 2

An electrolyte and a lithium secondary battery sample were manufactured in the same manner as in Example 1, except that 0.5 wt % of a compound represented by Chemical Formula 2-11 below was used instead of the compound represented by Chemical Formula 2-1 of Example 1.

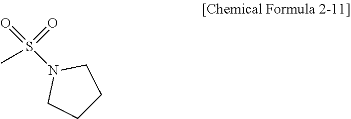

### Comparative Example 3

An electrolyte and a lithium secondary battery sample were manufactured in the same manner as in Example 1, except that 0.5 wt % of a compound represented by Chemical Formula 2-12 below was used instead of the compound represented by Chemical Formula 2-1 of Example 1.

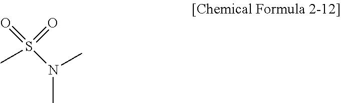

The compositions of the electrolytes of the examples and comparative examples are listed in Table 1 below.

TABLE 1

| | | | Auxiliary additive (wt %) | | |
|---|---|---|---|---|---|
| | Lithium salt | Additive (wt %) | FEC | LiPO₂F₂ | PS |
| Example 1 | LiPF₆ | Additive 1 | 5.0 | 1.0 | 0.5 |
| | (1.1M) | (0.5) | | | |
| Example 2 | LiPF₆ | Additive 2 | 5.0 | 1.0 | 0.5 |
| | (1.1M) | (0.5) | | | |
| Example 3 | LiPF₆ | Additive 3 | 5.0 | 1.0 | 0.5 |
| | (1.1M) | (0.5) | | | |
| Example 4 | LiPF₆ | Additive 1 | 5.0 | 1.0 | 0.5 |
| | (1.1M) | (0.25) | | | |
| Example 5 | LiPF₆ | Additive 1 | 5.0 | 1.0 | 0.5 |
| | (1.1M) | (1.0) | | | |
| Example 6 | LiPF₆ | Additive 2 | 5.0 | 1.0 | 0.5 |
| | (1.1M) | (0.25) | | | |
| Example 7 | LiPF₆ | Additive 2 | 5.0 | 1.0 | 0.5 |
| | (1.1M) | (1.0) | | | |
| Example 8 | LiPF₆ | Additive 3 | 5.0 | 1.0 | 0.5 |
| | (1.1M) | (0.25) | | | |
| Example 9 | LiPF₆ | Additive 3 | 5.0 | 1.0 | 0.5 |
| | (1.1M) | (1.0) | | | |
| Comparative | LiPF₆ | — | 5.0 | 1.0 | 0.5 |
| Example 1 | (1.1M) | | | | |
| Comparative | LiPF₆ | Additive 4 | 5.0 | 1.0 | 0.5 |
| Example 2 | (1.1M) | (0.5) | | | |
| Comparative | LiPF₆ | Additive 5 | 5.0 | 1.0 | 0.5 |
| Example 3 | (1.1M) | (0.5) | | | |

The components listed in Table 1 are as follows.
Additive 1: Compound represented by Formula 2-1
Additive 2: Compound represented by Formula 2-4
Additive 3: Compound represented by Formula 2-6
Additive 4: Compound represented by Formula 2-11
Additive 5: Compound represented by Formula 2-12
FEC: Fluoroethylene carbonate
LiPO₂F₂: Lithium difluorophosphate
PS: 1,3-Propanesultone

### EXPERIMENTAL EXAMPLE

Battery performance was evaluated by the following method, and the results are presented in Table 2 below.

### Experimental Example 1: Evaluation of Initial Performance

### (1) Evaluation of Initial Capacity

The lithium secondary batteries of the examples and comparative examples were subjected to 0.5 C-rate CC/CV charging (4.2 V, 0.05 C cut-off) at 25° C., followed by 0.5 C-rate CC discharging (2.7 V cut-off) for three cycles.

The discharge capacity value at the third cycle was defined as the initial capacity of the lithium secondary batteries and is presented in Table 2 below.

### (2) Evaluation of Initial Resistance

The lithium secondary batteries of the examples and comparative examples were tested at a 60% state of charge (SOC) point at 25° C. by sequentially varying the C-rate to 0.2 C, 0.5 C, 1.0 C, 1.5 C, 2.0 C, 2.5 C, and 3.0 C, while performing charging and discharging for 10 seconds at each C-rate. The terminal voltage points were plotted to construct a linear equation, and the slope of the resulting line was adopted as the DCIR (C-DCIR and D-DCIR were calculated as the slopes of linear fits to terminal voltage points obtained during 10-second charge and discharge pulses, respectively, while varying the C-rate from 0.2 C to 3.0 C.). The calculated values are presented in Table 2 below.

### Experimental Example 2: Evaluation of High-Temperature (60° C.) Storage Performance

### (1) Evaluation of Capacity Retention

The lithium secondary batteries of the examples and comparative examples were subjected to 0.2 C-rate CC/CV charging (4.2V, 0.05 C cut-off) at 25° C., and then stored in a constant-temperature and humidity chamber at 60° C. for 10 weeks.

The lithium secondary batteries of the examples and comparative examples stored at 60° C. for 10 weeks were subjected to 0.5 C-rate CC discharging (2.7 V cut-off), and then the discharge capacity after high-temperature storage was measured.

The capacity retention was calculated as a percentage of the discharge capacity after high-temperature storage relative to the initial capacity.

### (2) Evaluation of Resistance Increase Ratio

The lithium secondary batteries of the examples and comparative examples were subjected to 0.2 C-rate CC/CV charging (4.2V, 0.05 C cut-off) at 25° C., and then stored in a constant-temperature and humidity chamber at 60° C. for 10 weeks.

The lithium secondary batteries were tested at a 60% SOC point at 25° C. by sequentially varying the C-rate to 0.2 C, 0.5 C, 1.0 C, 1.5 C, 2.0 C, 2.5 C, and 3.0 C, while performing charging and discharging for 10 seconds at each C-rate. The terminal voltage points were plotted to construct a linear equation, and the slope of the resulting line was adopted as the DCIR.

The high-temperature internal resistance (DCIR) measured for the lithium secondary battery of Comparative Example 1 was assigned a value of 100, and the high-temperature internal resistances (DCIRs) measured for the lithium secondary batteries of all other examples and comparative examples were normalized relative thereto and are shown in Table 2 below. In Table 2, C-DCIR (or D-DCIR) increase ratio (%) is defined as a ratio (×100) of a post-storage value to an initial value of the C-DCIR (or D-DCIR), wherein the C-DCIR (or D-DCIR) is calculated as the slope of a linear fit to terminal voltage points obtained by applying a 10-second charge (or discharge) pulse while varying the C-rate from 0.2 C to 3.0 C.

### (3) Evaluation of Thickness Increase Ratio

The lithium secondary batteries of the examples and comparative examples were subjected to 0.5 C-rate CC/CV charging (4.2 V, 0.05 C cut-off) at 25° C., and then the battery thickness T1 was measured. The charged lithium secondary batteries were then exposed to air at 60° C. for 10 weeks using a constant-temperature device, and the battery thickness T2 was measured.

The battery thickness was measured using a flat plate thickness measuring device (Mitutoyo, 543-490B). The battery thickness increase ratio was calculated according to the following equation, and the results are presented in Table 2 below.

$$Battery thickness increase ratio ( \% ) = \{ ( T 2 - T 1 ) / T 1 \} \times 100$$

TABLE 2

| | | | | High-temperature (60° C.) storage performance | | | |
|---|---|---|---|---|---|---|---|
| | Initial performance | | | (10 weeks) | | | |
| | | C- | D- | Capacity | C-DCIR | D-DCIR | Thickness |
| | Capacity | DCIR | DCIR | retention | increase | increase | increase |
| | (mAh) | (mΩ) | (mΩ) | (%) | ratio (%) | ratio (%) | ratio (%) |
| Example 1 | 1875 | 31.8 | 33.8 | 84 | 133 | 131 | 18 |
| Example 2 | 1872 | 31.9 | 34.5 | 81 | 130 | 132 | 23 |
| Example 3 | 1879 | 33.1 | 35.8 | 80 | 131 | 132 | 26 |
| Example 4 | 1884 | 30.9 | 33.0 | 79 | 136 | 134 | 22 |
| Example 5 | 1828 | 30.6 | 33.5 | 79 | 136 | 135 | 24 |
| Example 6 | 1834 | 33.9 | 36.4 | 79 | 123 | 126 | 25 |
| Example 7 | 1816 | 32.3 | 35.9 | 79 | 137 | 135 | 27 |
| Example 8 | 1830 | 34.6 | 36.3 | 78 | 127 | 125 | 22 |
| Example 9 | 1862 | 32.8 | 34.9 | 80 | 131 | 133 | 26 |
| Comparative | 1863 | 32.4 | 35.7 | 74 | 140 | 146 | 33 |
| Example 1 | | | | | | | |
| Comparative | 1853 | 31.8 | 33.8 | 73 | 142 | 142 | 31 |
| Example 2 | | | | | | | |
| Comparative | 1870 | 31.3 | 33.7 | 74 | 138 | 140 | 30 |
| Example 3 | | | | | | | |

Referring to Tables 1 and 2, the lithium secondary batteries of the examples including sulfonamide-based compounds in which aromatic groups are bound to sulfur atoms exhibited improved high-temperature (60° C.) storage performance (reduced resistance increase ratio and thickness increase ratio) and cycle-life properties (increased capacity retention).

However, the lithium secondary battery of Comparative Example 1, which did not use the compound represented by Formula 2-1, exhibited low capacity retention and high resistance increase ratio and thickness increase ratio during high-temperature storage.

In addition, the lithium secondary batteries of Comparative Examples 2 and 3, which used additives including compounds having a structure in which aromatic groups are not bound to sulfur atoms, exhibited low capacity retention and high resistance increase ratio and thickness increase ratio during high-temperature storage.

The contents described above are merely examples of applying the principles of the present disclosure, and other configurations may be further included without departing from the scope of the present disclosure.

What is claimed is:

1. An electrolyte for a lithium secondary battery comprising:
a compound represented by Chemical Formula 1 below, and
a lithium salt: 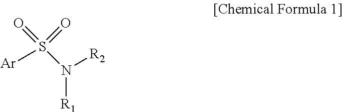
wherein in Chemical Formula 1, Ar is a substituted or unsubstituted aryl group having 6 to 30 carbon atoms, and
R₁ and R₂ are each independently a substituted or unsubstituted alkyl group having 1 to 10 carbon atoms, a substituted or unsubstituted arylalkyl group having 7 to 20 carbon atoms, a substituted or unsubstituted alkylsulfonyl group having 1 to 10 carbon atoms, or a substituted or unsubstituted arylsulfonyl group having 6 to 30 carbon atoms, or alternatively, R₁ and R₂ are bonded to each other to form a heterocycle having 3 to 10 carbon atoms.

2. The electrolyte for a lithium secondary battery according to claim 1, wherein in Chemical Formula 1, Ar is a substituted or unsubstituted phenyl group.

3. The electrolyte for a lithium secondary battery according to claim 1, wherein in Chemical Formula 1, R₁ and R₂ are each independently a substituted or unsubstituted alkyl group having 1 to 6 carbon atoms, a substituted or unsubstituted arylalkyl group having 7 to 15 carbon atoms, or a substituted or unsubstituted arylsulfonyl group having 6 to 12 carbon atoms.

4. The electrolyte for a lithium secondary battery according to claim 1, wherein in Chemical Formula 1, at least one of R₁ and R₂ is a phenylsulfonyl group.

5. The electrolyte for a lithium secondary battery according to claim 1, wherein in Chemical Formula 1, at least one of R₁ and R₂ is a benzyl group.

6. The electrolyte for a lithium secondary battery according to claim 1, wherein in Chemical Formula 1, R₁ and R₂ are bonded to each other to form a heterocycle having 4 to 8 carbon atoms.

7. The electrolyte for a lithium secondary battery according to claim 1, wherein the compound represented by Chemical Formula 1 comprises a compound represented by any one of Chemical Formulae 2-1 to 2-7 below:

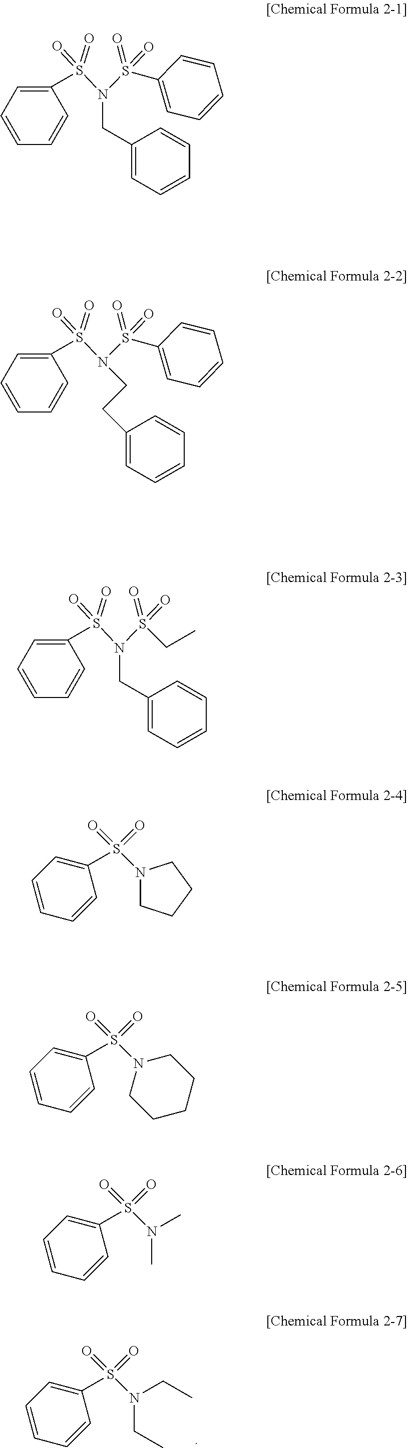

8. The electrolyte for a lithium secondary battery according to claim 1, wherein a content of the compound represented by Formula 1 is greater than 0 wt % and 5 wt % or less based on a total weight of the electrolyte.

9. The electrolyte for a lithium secondary battery according to claim 1, further comprising an organic solvent, wherein the organic solvent includes at least one selected from the group consisting of a carbonate-based solvent, an ester-based solvent, an ether-based solvent, a ketone-based solvent, an alcohol-based solvent, and an aprotic solvent.

10. The electrolyte for a lithium secondary battery according to claim 1, further comprising at least one auxiliary additive selected from the group consisting of a cyclic carbonate-based compound, a fluorine-containing carbonate-based compound, a lithium phosphate-based compound, a sultone-based compound, a borate-based compound, a sulfate-based compound, and a sulfite-based compound.

11. The electrolyte for a lithium secondary battery according to claim 10, wherein a total content of the auxiliary additive is greater than 0 wt % and 10 wt % or less based on a total weight of the electrolyte.

12. A lithium secondary battery comprising:
an electrode assembly comprising a cathode and an anode; and
the electrolyte for a lithium secondary battery according to claim 1.

13. The lithium secondary battery according to claim 12, wherein a solid-electrolyte interphase (SEI) film is formed on a surface of at least one of the cathode and the anode, and
wherein the SEI film comprises at least one of sulfur (S) and lithium nitride (Li₃N).
